(19) United States
(12) Patent Application Publication
(10) Pub. No.: US 2025/0086551 A1
(43) Pub. Date: Mar. 13, 2025

(54) System and Method for Assessing Actions of Authenticated Entities Within an Enterprise System

(71) Applicant: The Toronto-Dominion Bank, Toronto (CA)

(72) Inventor: Huifang ZHAO, Brampton (CA)

(73) Assignee: The Toronto-Dominion Bank, Toronto (CA)

(21) Appl. No.: 18/466,090

(22) Filed: Sep. 13, 2023

(51) Int. Cl. G06Q 10/0635; G06N 20/00; H04L 9/40

(52) U.S. Cl. CPC G06Q 10/0635; G06N 20/00; H04L 63/08

(57) ABSTRACT

A system, device and method are provided for assessing actions of authenticated entities within an enterprise system. The illustrative method includes receiving a request from an authenticated user to perform an action with an enterprise computing resource, and processing the request with an anomaly detector to generate a risk assessment. The anomaly detector uses a machine learning model trained to predict a likelihood that an adverse event will result from completion of actions by authenticated users to generate the risk assessment. The method includes assessing the generated risk assessment with a remediation tool to determine whether to serve one or more remediation actions to evaluate the request, and having the remediation action executed in response to the remediation tool determining at least one remediation action is required to complete the actions of the request.

### TECHNICAL FIELD

The following relates generally to enterprise security, and more particularly to assessing actions of authenticated entities within an enterprise system.

### BACKGROUND

Existing enterprise security systems focus on preventing adverse parties from gaining access to an enterprise system. These approaches are also in part disassociated with the adverse actions performed by the adverse party. That is, some existing approaches focus on gatekeeping access to an enterprise system as a whole, and failures may only become apparent after all the actions have been completed.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration for training a security platform according to the disclosure herein.

FIG. 3A and 3B are each a block diagram of an example configuration for deploying a security platform according to the disclosure herein.

FIG. 4 is a block diagram of an example configuration of a security platform according to the disclosure herein.

FIG. 5 is a block diagram of an example configuration of an enterprise system.

FIG. 6 is a block diagram of an example configuration of a user device.

FIG. 7 is a flow diagram of an example method performed by computer executable instructions for assessing actions of authenticated entities within an enterprise system.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Existing enterprise security systems focus on preventing an adverse party from accessing the enterprise system; this disclosure includes an approach that focuses on security approaches to implement for actions of already validated users (alternatively referred to as insiders) of an enterprise.

For enterprise users that are already granted a certain level of access to data within the enterprise, there exists a risk that these users can do damage to the data or the enterprise more widely. For example, files can be imported into emails or onto a user's computer or may be manually exchanged with other teams, for both inbound and outbound data. In another example, some sensitive data such as the results of employee criminal checks, which may not be encrypted, can be loaded onto a user's laptop should they have access to this data.

Currently, manual processes are used to check for internal risks by accessing data. This includes a manual workflow and manual data processing along with a manual approach to insider risk management. Moreover, it is found that these manual processes provide an incomplete view of all insider risks across the enterprise.

There is a need to provide a more robust and automated system or platform that can monitor insider risk more carefully without introducing unacceptable intrusiveness (e.g., reducing the user experience), especially for those users posing little to no risk to an organization.

A computer architecture structure that can handle the computing power required to assess the large amounts of actions within an organization is disclosed. The disclosed computer architecture is directed towards at least two problems necessarily rooted in computer technology: implementing accurate security systems for an enterprise while balancing the level of intrusiveness of the security evaluation process. In addition, the computer architecture disclosed relates to real world applications to enable automated and proactive remediation for detected insider risk remediation, in real-time, and not after the fact. The disclosure may advantageously reduce inadvertent or unintended risky behaviour by forcing users with such habits to remediate to perform their requests.

The disclosure includes an anomaly detector and cooperating remediation tools, the anomaly detector using machine learning based on historical behaviours as well as different policies to differentiate internal actions that require remediation (i.e., are sufficiently risky) and those that do not. The cooperating remediation tools can assess the risks detected by the anomaly detector to assess whether remediation is appropriate, and based on that assessment, initiate a remediation action to proactively address security issues at the outset, prior to the action being completed by the user.

In one aspect, a device for assessing actions of authenticated entities within an enterprise system is disclosed. The device includes a processor, a communications module coupled to the processor, and a memory coupled to the processor. The memory stores computer executable instructions that, when executed by the processor, cause the processor to receive a request from a user to perform an action with an enterprise computing resource. The user providing the request is authenticated according to one or more authentication criteria. The processor is caused to process the request with an anomaly detector to generate a risk assessment. The anomaly detector uses a machine learning model trained to predict a likelihood that an adverse event will result from completion of actions by authenticated users to generate the risk assessment. The processor is caused to assess the generated risk assessment with a remediation tool to determine whether to serve one or more remediation actions to evaluate the request. The processor is caused to have the remediation action executed in response to the remediation tool determining at least one remediation action is required to complete the actions of the request.

In example embodiments, the device is a proxy server positioned between a user device associated with the user and an enterprise platform hosting the enterprise computing resource, and wherein the anomaly detector processes the request after the request is provided to the proxy server.

In example embodiments, the instructions cause the processor to, in response to the remediation action being successfully completed, enable completion of the action.

In example embodiments, the remediation action can include a further authentication, or an actionable event from a user other than the user associated with the request.

In example embodiments, the instructions cause the processor to assess a data source used to train the machine learning model to determine whether a threshold associated with data drift is satisfied. In response to the threshold being satisfied, the processor re-trains the machine learning model with the data source to reduce an amount of data drift.

In example embodiments, the instructions cause the processor to retrieve the machine learning model from a container image registry. The container image registry includes a plurality of machine learning models in a form of container packages.

In example embodiments, the enterprise resources are cloud computing resources.

In example embodiments, the remediation tools assess the generated risk assessment based on at least one of risk acceptability parameters and intrusiveness parameters.

In example embodiments, the remediation tools assess the generated risk assessment based on at least one of functionality associated with the action, a role associated with the user, the requested action, and the enterprise computing resource.

In another aspect, a method of assessing actions of authenticated entities within an enterprise system is disclosed. The method includes receiving a request from a user to perform an action with an enterprise computing resource of an enterprise platform. The user providing the request is authenticated according to one or more authentication criteria. The method includes processing the request with an anomaly detector to generate a risk assessment. The anomaly detector uses a machine learning model trained to predict a likelihood that an adverse event will result from completion of actions by authenticated users to generate the risk assessment. The method includes assessing the generated risk assessment with a remediation tool hosted on the enterprise platform to determine whether to serve one or more remediation actions to evaluate the request. The method includes having the remediation action executed in response to the remediation tool determining at least one remediation action is required to complete the actions of the request.

In example embodiments, the request is received by a proxy server positioned between a user device associated with the user and the enterprise platform hosting the enterprise computing resource, and the anomaly detector processes the request after the request is provided to the proxy server.

In example embodiments, the method includes, in response to the remediation action being successfully completed, enabling access via the proxy server to the enterprise computing resource to complete the action.

In example embodiments, the anomaly detector is operable on a user device associated with the user, and the anomaly detector provides the generated risk assessment to the remediation tool hosted on the enterprise platform.

In example embodiments, the method includes generating, within the enterprise platform, an updated machine learning model, packaging the updated machine learning model into a container image, and updating the machine learning model of the user device with the updated machine learning model in the container image.

In example embodiments, the remediation action is served to the user device via the proxy server.

In example embodiments, the remediation action is served to a user other than the user associated with the request, the remediation action being served via a channel separate from the proxy server.

In example embodiments, the method includes assessing a data source used to train the machine learning model to determine whether a threshold associated with data drift is satisfied. The method includes, in response to the threshold being satisfied, re-training the machine learning model with the data source to reduce an amount of data drift.

In example embodiments, the remediation action can include a further authentication, or an actionable event from a user other than the user associated with the request.

In example embodiments, the remediation tool assesses the generated risk assessment based on at least one of risk acceptability parameters, intrusiveness parameters, and a baseline acceptable risk.

In another aspect a non-transitory computer readable medium for assessing actions of authenticated entities within an enterprise system is disclosed. The computer readable medium includes computer executable instructions for receiving a request from a user to perform an action with an enterprise computing resource. The user providing the request is authenticated according to one or more authentication criteria. The instructions are for processing the request with an anomaly detector to generate a risk assessment. The anomaly detector uses a machine learning model trained to predict a likelihood that an adverse event will result from completion of actions by authenticated users to generate the risk assessment. The instructions are for assessing the generated risk assessment with a remediation tool to determine whether to serve one or more remediation actions to evaluate the request. The instructions are for having the remediation action executed in response to the remediation tool determining at least one remediation action is required to complete the actions of the request.

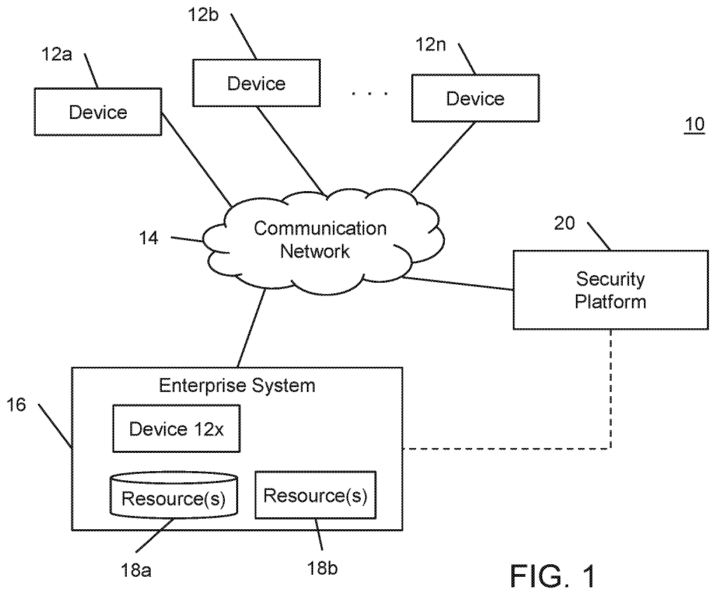

FIG. 1 illustrates an exemplary computing environment 10 in which the elements of the disclosed system(s) may operate. The computing environment 10 can include one or more user devices 12, a communications network 14 connecting one or more components of the computing environment 10, an enterprise system 16, and a security platform 20.

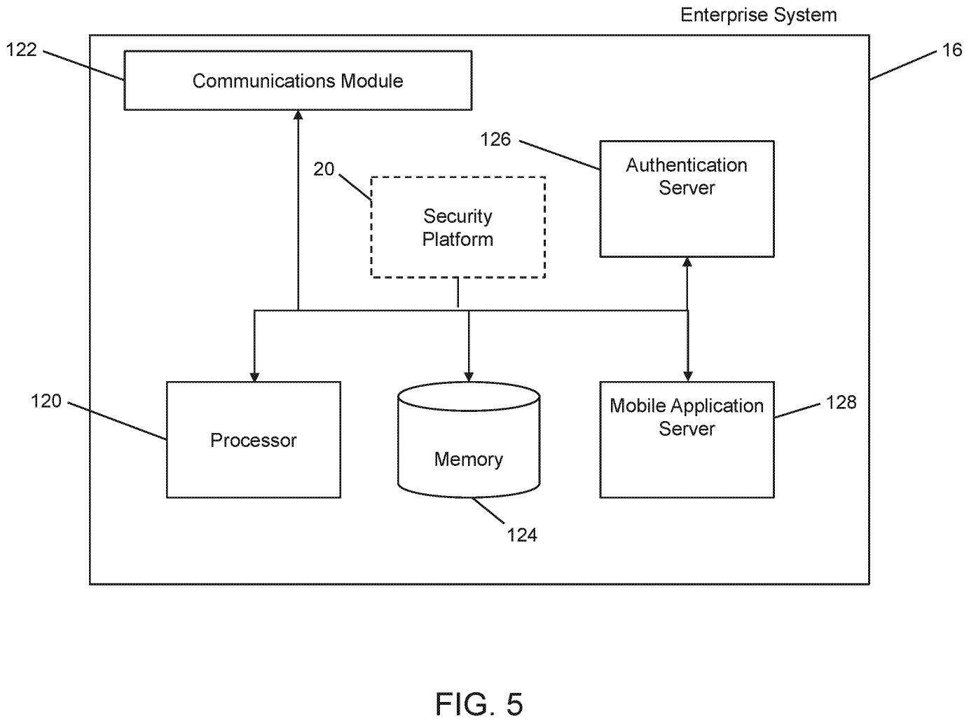

The enterprise system 16 (e.g., a financial institution such as commercial bank and/or lender) can be a system that provides a plurality of services via a plurality of enterprise resources (e.g., the shown database resources 18a, and computing resources 18b). The enterprise services can be provided by dedicated computing resources 18 (e.g., via dedicated hardware), or through resources 18 shared amongst the enterprise 16. The enterprise resources 18 can be provided by the enterprise system 16, or by a third party contracted by the enterprise system 16 (e.g., a cloud computing provider), etc. In an example embodiment, the enterprise system 16 is a system that includes sensitive computing resources 18, such as records of financial services or user accounts or transactions associated with those financial service accounts. While several details of the enterprise system 16 have been omitted for clarity of illustration, reference will be made to FIG. 5 below for additional details.

It can be appreciated that while the security platform 20 and enterprise system 16 are shown as separate entities in FIG. 1, they may also be part of the same system. For example, the security platform 20 can be hosted and provided within the enterprise system 16 as illustrated in FIG. 5.

User devices 12 may be associated with one or more users which can have authenticated access to the enterprise resources 18 or system 16. Users may be customers, employees, contractors, regulators, or other entities that interact with the enterprise system 16 and/or security platform 20 (directly or indirectly). The computing environment 10 may include multiple user devices 12, each user device 12 being associated with a separate user or associated with one or more users. The client devices can be external to the enterprise system 16 (e.g., the shown devices 12a, 12b, to 12n), or internal to the enterprise system 16 (e.g., the shown device 12x). In certain embodiments, a user may operate user device 12 such that user device 12 performs one or more processes consistent with the disclosed embodiments. For example, the user may employ user device 12 to generate requests to use enterprise resources 18, perform remediation tasks, etc.

User devices 12 can include, but are not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of user devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network, and a private and/or public wide area network (e.g., the Internet).

Security platform 20 can be configured to process and store information and execute software instructions to perform one or more processes consistent with the disclosed embodiments.

The security platform 20 and/or enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public, and private keys in a PKI), and perform other cryptographic operations that are required or desired for particular applications of the security platform 20 and enterprise system 16. The cryptographic server may, for example, be used to protect the financial data and/or client data and/or transaction data within the enterprise resources 18 by way of encryption for data protection, digital signatures or message digests for data integrity, and by using digital certificates to authenticate the identity of the users and user devices 12 with which the enterprise system 16 and/or security platform 20 communicates to inhibit misuse. It can be appreciated that various cryptographic mechanisms and protocols can be chosen and implemented to suit the constraints and requirements of the particular deployment of the security platform 20 or enterprise system 16 as is known in the art.

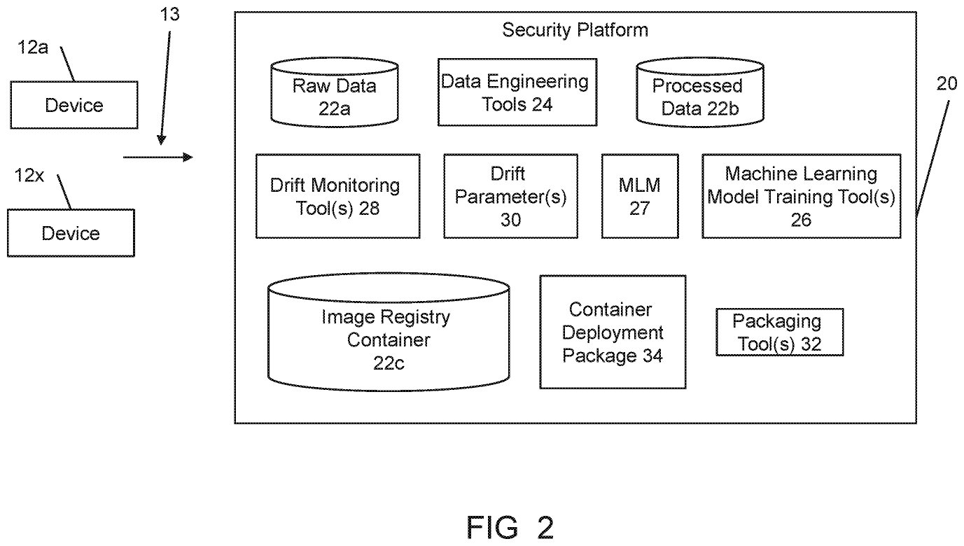

FIG. 2 provides a block diagram of an example configuration for training the security platform 20 for assessing actions of authenticated entities within an enterprise system. As shown in the example embodiment, a user device 12 (either a device external to the enterprise system 16, shown as device 12a, or a device internal to the enterprise system 16, shown at device 12x) submits a request 13 to perform an action with enterprise computing resource(s) 18 (hereinafter generally referred to in the singular, for ease of reference). The action associated with the request 13 can include a single action, plurality of actions, an action requiring multiple enterprise resources 18, a plurality of actions requiring a plurality of different enterprise resources 18, etc. The action can include a read, write, or edit action to existing data in the enterprise system 16, a series of such actions, etc. The action can include using computing resource 18 to read, write, or edit other computing resources 18 of the enterprise system 16, using computing resource 18 to read, write, or edit computing resources to which the computing resources 18 act as a gatekeeper (e.g., resources stored by a subcontractor of the enterprise system 16 etc.), and so forth.

The request 13 is provided to the security platform 20. The security platform 20 may receive the request 13 directly from the user device 12, or indirectly, for example through a proxy server.

The request 13 can include or imply at least one parameter indicating that the user of the device 12 making the request 13 is authenticated according to one or more authentication criteria. For example, the communication channel (e.g., the communication network 14) used to provide the request 13 to the security platform may be a channel (e.g., a wired network within the enterprise system 16, only accessible the authentication) dedicated to authenticated users. In another example, the request may be received from a device 12a of an employee working from home who has authenticated to access enterprise resource 18.

The request 13, in addition to originating from an authenticated user, can also be a request 13 for resources 18 to which the user has adequate permissions to act on. For example, the user generating the request 13 may be an administrator who otherwise has access rights to the computing resource 18 needed to fulfill the request 13. As alluded to above, in an example embodiment, unlike traditional systems, which aim to prevent unauthorized use, the present disclosure can be directed to requests 13 that are technically considered to be proper within the existing security authentication and permissions definitions.

The security platform 20 may impose one or more conditions on any requests to access the computing resource 18. For example, the security platform 20 can require any request 13 to be accompanied by various parameters associated with the user history, such as: the user activity on the device 12 for the past X minutes, other recently accessed computing resource 18, the means used to access the security platform 20, the means used to access the enterprise system 16, information required to determine the permissions/role of the user submitting the request 13, and IP address of the device 12 used to submit the request 13, etc.

The request 13, and data associated with the one or more imposed conditions (hereinafter referred to simply as the raw request 13, for ease of reference) can be stored in a raw database 22a.

One or more data engineering tools 24 can be used to process the raw request 13. The data engineering tools 24 can include tools to format the raw request 13 into a format accepted by machine learning models (MLMs) which will be applied to incoming requests. The data engineering tools 24 can include tools to remove extraneous data, e.g., if the raw request 13 is used for plurality of purposes, and the security platform 20 only requires a certain subset of data therein. The data engineering tools 24 can include one or more tools to parse the received requests 13 to identify one or more specific properties of a request 13.

The data engineering tools 24 can include one or more tools to determine one or more features based on the request 13. The features can include data present in the request 13, or derivations based on the data present in the raw request 13, e.g., a token representing the time the request was submitted and the location in which the request 13 originated. In another example, the features can include tokens which represent a combination of the user submitting the request, the type of request, and the time and location associated with the request.

Raw requests 13 processed by the data engineering tools 24 can be stored in the processed database 22b (hereinafter referred to as processed requests 13, for ease of reference). The processed requests 13 stored in the processed database 22b can be used solely as a store for the machine learning model training tools 26, or they can be integrated into another database (not shown) that may serve the features of the processed requests 13 for other purposes.

The machine learning model training tools 26 (hereinafter tools 26, for ease of reference) process the processed requests 13 (including, if any, features derived therefrom) to generate one or more machine learning models (shown as MLM(s) 27, referred to in the singular for ease of reference). The tools 26 can be used to train a variety of different MLMs 27 (e.g., deep convolutional neural networks (CNNs), CNNs with different architecture and activation models, etc.). The tools 26 can be used to implement a variety of training techniques to generate the MLM 27. For example, the MLM 27 can be trained to receive different features, to have different step sizes during regression, etc.

In at least some example embodiments, the processed database 22b is curated with examples of behavior (e.g., historical behaviors) that the MLM 27 is expected to emulate, and to learn parameters relevant to emulation thereof and examples which the MLM 27 is expected to avoid, and learn parameters relevant to emulation thereof. That is, the MLM 27 may be trained with a curated set of examples of accurate assessments of actions of authenticated entities within an enterprise system 16, and where the assessments are inaccurate (e.g., an action by an authenticated user that should have been flagged as requiring remediation actions was not flagged as such). The curated examples can also include examples of unwarranted or overaggressive findings that remediation actions are required to complete the request 13. The latter examples may be given an elevated importance (e.g., via the number of examples included in the training exercise, both as an amount and variety) if the disclosed system is intended to focus on low intrusiveness.

The training of the MLM 27 can focus on generating an MLM 27 which optimizes speed in favor of a degree of accuracy. For example, as the MLM 27 can be implemented throughout the enterprise system 16 to all requests 13 to access enterprise resources 18 (i.e., a huge amount of request), it can be trained to be minimally intrusive so as to not unduly impede workflows of employees. Continuing the example, the MLM 27 can be trained to require remediation actions only where there is a high degree of certainty that such actions are warranted.

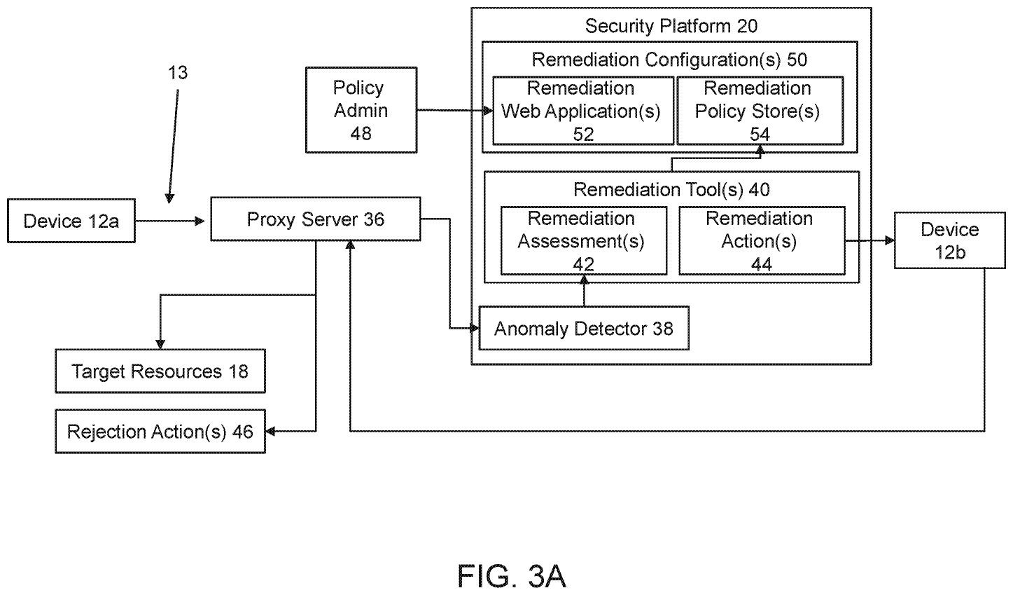

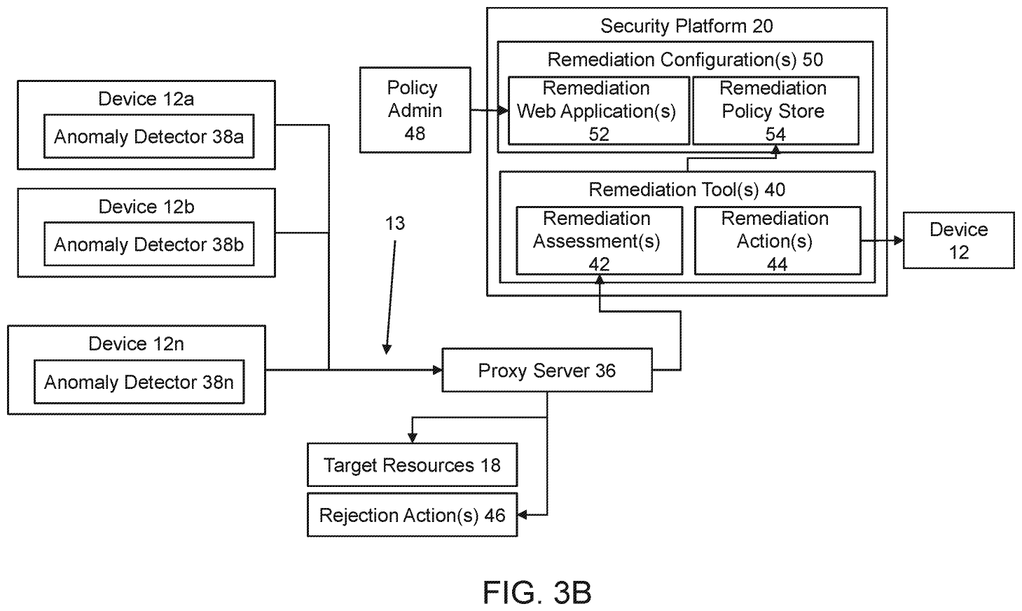

The trained MLMs 27 are packaged for deployment with one or more packaging tools 32 which generate deployment packages 34. For example, the packaging tools 32 can be tools configured to package the MLMs 27 for a proxy server (FIG. 3) to integrate with the computing environment therein. The packaging tools 32 can be used to prepare the MLM 27 for deployment for a specific device 12 configuration, where a plurality of device configurations are possible (e.g., one device 12 is running a first build, another device 12 is running another build, etc.).

The trained MLM 27 can output a risk assessment. The risk assessment can include a measure of the likelihood that an adverse event will result from completion of actions in the request by authenticated users, and a confidence in the likelihood assessment, a categorization of the request 13, etc. (e.g., high priority, important action, etc.).

The deployment packages 34 generated by the packaging tools 32 can be stored in a container 22c. The container 22c can be configured to automatically update subscribed devices 12 with updated deployment packages 34 relevant to the device's computing environment 10. In example embodiments, the build packages are pushed out of the container 22c to ensure that all devices 12 are running the latest threat detection software.

After deployment of the MLM 27 (e.g., via a deployed deployment package 34), the operational outcomes related to the MLM 27 can be tracked. For example, the raw database 22a can be configured to log received requests 13 along with outcomes resulting from the received requests 13 being processed by the MLM 27 (e.g., via the anomaly detector 38 of FIG. 3A) for subsequent training.

Drift monitoring tool(s) 28, alongside drift parameter(s) 30 (hereinafter both referred to in the plural, for ease of reference), are used to monitor the operational outcomes of deployed MLM 27 for drift. For clarity, drift in this disclosure includes, but is not limited to, a change (as defined by the parameters 30) to the circumstances such that MLM 27 recommendations for remediation actions (or lack thereof) do not align with desired recommendations (e.g., the request 13 should be recommended for remediation actions, but the MLM 27 declined to impose them).

The drift parameters 30 can include a plurality of parameters associated with a change in circumstances, and at least one parameter that is indicative of whether a retraining of the MLM 27 is warranted. The plurality of parameters can include parameters associated with changes to the permissions granted to roles (e.g., the MLM 27 may need periodic updating as the nature of roles changes; what was once a task assigned to a relatively senior employee may lose importance and more regularly be the responsibility of a more junior employee), changes to employee patterns in generating requests 13 (e.g., COVID-19 resulted in increased work from home arrangements, and therefore associated changes with devices and locations associated with requests 13. Changes to workplace attendance policies can rapidly change these parameters, and the MLM 27 may erroneously detect workplace-initiated requests 13 as inherently being more deserving of remediation actions), changes to the risk appetite of the enterprise system 16 (e.g., the enterprise may segment the enterprise system 16 such that risk tolerance changes for different segments of the system 16), changes in architecture associated with the deployment of the MLM 27 (e.g., the architecture may change from a proxy server implementation to an on device 12 implementation), changes to enterprise policy (e.g., needed to comply with legal requirements, computing may become less expensive and the enterprise 16 can adjust the MLM 27 to improve accuracy), changes to device performance (e.g., a particular device 12 configuration cannot process requests in a desired time), etc.

The at least one parameter that is indicative of whether a retraining of the MLM 27 is warranted can be a derivative parameter, which is based on the plurality of parameters of drift parameters 30. For example, the at least one parameter can be based on a cumulative assessment of the plurality of parameters (e.g., the MLM 27 requires remediation actions for 20% more than intended, 3 out of 4 thresholds associated with the parameter have been breached, etc.), or some combination of them, etc.

The drift monitoring tools 28 are used to monitor the parameters 30. The monitoring can occur periodically, on request, etc. The monitoring tools 28 can include tools to monitor role definitions (e.g., a comparison of the job posting for similar positions over the years), to monitor employee location data, to monitor corporate policy documents, etc., and more generally monitor data sources relevant to the parameters 30. In example embodiments, the drift monitoring tools 28 monitor data in the requests 13, data from other enterprise sources (e.g., from enterprise databases other than the databases 22), or from external sources (e.g., from application data installed on employee mobile devices 12).

Upon detecting drift based on the parameters 30, the drift monitoring tools 28 can generate a notification that the relevant MLM 27 needs to be retrained, or can automatically initiate retraining with the data used to assess the drift. The retrained MLM 47 can be similarly packaged and stored in the container 22c for deployment.

Referring now to FIG. 3A, a block diagram of an example configuration for deploying a security platform 20 is shown. In the shown embodiment, requests 13 to access the computing resources 18 are routed through a proxy server 36 (requests can be ignored unless directed via the proxy server 36). That is, the proxy server 36 can be positioned between a user device 12a associated with the user and the enterprise computing resources 18, wherein an anomaly detector 38 processes the request 13 after the request 13 is provided to the proxy server 36.

The proxy server 36 can route requests 13 to an anomaly detector 38 (i.e., a deployed package 34). The anomaly detector 38 can utilize the trained MLM 27 to predict a likelihood that an adverse event will result from completion of actions within the requests 13 (which requests are associated with authenticated users) to generate the risk assessment.

The risk assessment is provided to the remediation tools 40. The remediation tools 40 include a remediation assessment tool 42 which processes the risk assessment to determine whether to serve one or more remediation actions to evaluate the request 13. The determination is performed according to configuration policies 50, which can include a policy store 54. A plurality of policies can be included in the policy store 54, including policies based on a risk appetite (e.g., requiring a certain confidence, or certain likelihood of an adverse event), a range of risk appetites (e.g., a baseline level of acceptable risk for all actions, a maximum risk applied to certain subgroups, etc.) policies based on the nature of the actions requested (e.g., a policy can be resource 18 specific, where changes to certain data may err on overprotective determinations), and policies based on intrusion, such as policies defining which remediation action 44 is appropriate in the event of a flagged action (e.g., senior level employees are served with the most time efficient remediation actions 44, whereas more junior employees are served with remediation actions 44 that can be more time consuming), policies based on the role of the user, and so forth. Policy administrators 48 can update the policy store 54 via a web application 52.

In response to the remediation assessment tool 42 determining at least one remediation action 44 is required in order to complete the actions of the request 13, the platform 20 can organize the necessary resources to serve the remediation action 44. For example, the remediation action 44 can require confirmation from a supervisor, and the platform 20 can determine the contact information for the relevant supervisor, ensure the correct notification is generated for the channel used to contact the supervisor, etc.

The at least one remediation action 44 can include two factor authentication (2FA) with known contact information for two different channels for the user associated with the request 13, or other actionable items from the user generating the request 13. The at least one remediation action 44 can include authentication by a user other than the user submitting the request 13 (e.g., the supervisor example discussed herein). The at least one remediation action 44 can include a plurality of remediation actions 44 that are chosen at random to be served (e.g., a Captcha, 2FA, bespoke remediation actions such as questions based on recent activity of the user performing the request 13, etc.). The remediation action 44 can take the form of an alert (e.g., a supervisor alert), a notification (e.g., an email, an auditory notification, etc.).

The platform 20 serves the at least one remediation action 44 on the device 12 as required by the remediation action 44 (e.g., the remediation action 44 can require input from a device 12b other than the device 12a submitting the request, as shown in FIG. 3A, or solely from the device 12a (not shown), etc.). The platform 20 can serve or otherwise provide the remediation action 44 directly, or via a proxy server 36, or otherwise.

The proxy server 36 can be configured to listen to events associated with the remediation action 44. If a remediation action 44 is successfully completed, the proxy server 36 can enable completion of actions to the resources 18 associated with the authenticated request 13. If the remediation action 44 is not successfully completed, the proxy server 36 can execute one or more rejection actions 46 (e.g., an error message, a notification to security personnel of the attempt to access resources 18, etc.).

A centralized instance of the anomaly detector 38 on the platform 20 can advantageously remove the need to generate anomaly detector 38 instances for different devices (e.g., as shown in FIG. 3B). In addition, the centralized anomaly detector 38 can take advantage of cloud computing resources to achieve efficiencies of scale and provide on-demand computing, and potentially provide fewer security risks associated with the implementation of the anomaly detector 38 (e.g., an adverse actor would have to get access to the platform 20 to inspect the anomaly detector 38).

FIG. 3B shows a block diagram of another example configuration for deploying a security platform 20. In the shown embodiment, an instance of the anomaly detector 38 is implemented on each device 12 making requests. The on device 12 anomaly detector 38 generates risk assessments of requests 13 entered by the user to provide to the proxy server 36.

In this way, the security platform 20 latency may be improved, as the distributed computing power of the devices 12 is employed as compared to a centralized anomaly detector 38 within the platform 20. In addition to potentially increased speed, the use of local instances of the anomaly detector 38 can reduce the amount of data trafficked between the proxy server 36 and the platform 20 (e.g., the server 36 may only provide the risk assessment to the platform 20), thereby making the communication more robust by disclosing less potentially sensitive information, decreasing latency, etc.

Similar to FIG. 3A, the security platform 20 can process the risk assessment with the remediation tools 40.

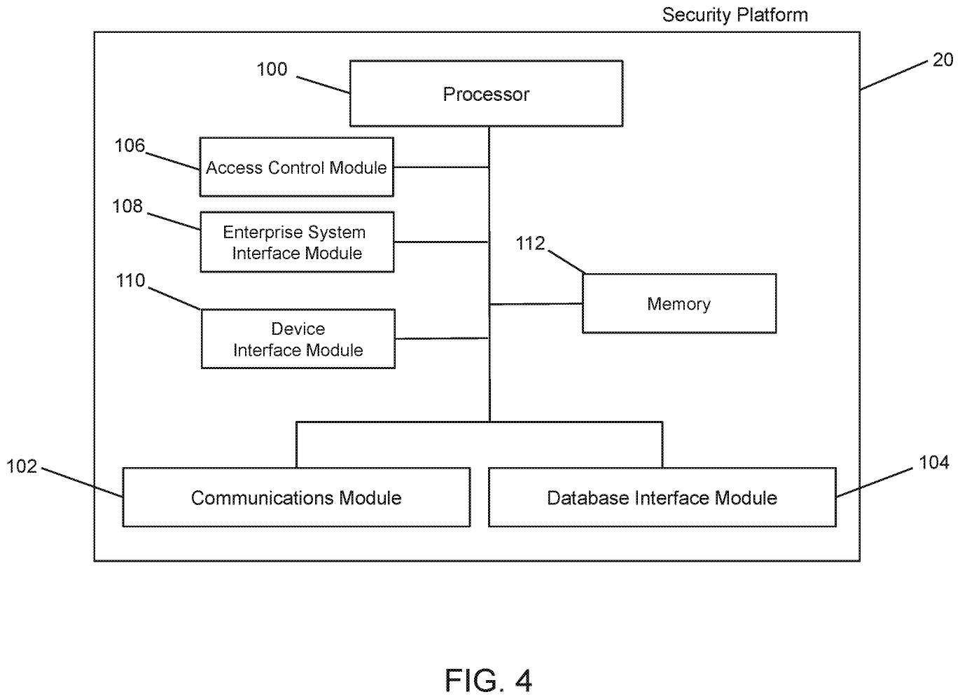

In FIG. 4, an example configuration for the security platform 20 is shown. In certain embodiments, the security platform 20 may include one or more processors 100, a communications module 102, and a database interface module 104 for interfacing with the resources 20a to retrieve, modify, and store (e.g., add) data. Communications module 102 enables the security platform 20 to communicate with one or more other components of the computing environment 10, such as user device 12 (or one of its components), via a bus or other communication network, such as the communication network 14. The security platform 20 includes at least one memory or memory device 112 that can include a tangible and non-transitory computer-readable medium having stored therein computer programs, sets of instructions, code, or data to be executed by processor 100.

FIG. 4 illustrates examples of modules, tools and engines stored in memory 112 on the security platform 20 and operated or executed by the processor 100, but intentionally omits components described in FIGS. 2 and 3a, 3b to maintain visual clarity.

It can be appreciated that any of the modules, tools, and engines shown in FIG. 4 may also be hosted externally and be available to the security platform 20, e.g., via the communications module 102.

In the example embodiment shown in FIG. 4, the security platform 20 includes an access control module 106, an enterprise system interface module 108, and a device interface module 110. The access control module 106 may be used to apply a hierarchy of permission levels or otherwise apply predetermined criteria to determine what aspects of the security platform 20 can be accessed by user devices 12, what resources 18 the platform 20 can access, and/or how related data can be shared with which entity in the computing environment 10. For example, the security platform 20 may have been granted access to certain resources 18, but not other resources. In another example, the access control module 106 can be used to control which users are permitted to alter policies stored in the remediation policy store 54. As such, the access control module 106 can be used to control the sharing of resources 18 or aspects of the platform 20 based on a type of client/user, a permission or preference, or any other restriction imposed by the computing environment 10 or application in which the security platform 20 is used.

The enterprise system interface module 108 can provide a graphical user interface (GUI), software development kit (SDK) or API connectivity to communicate with the enterprise system 16. It can be appreciated that the enterprise system interface module 108 may also provide a web browser-based interface, an application or “app” interface, a machine language interface, etc. Similarly, the device interface module 110 can provide a graphical user interface (GUI), software development kit (SDK) or API connectivity to communicate with user devices 12.

In FIG. 5, an example configuration for an enterprise system 16 is shown. In certain embodiments, similar to the security platform 20, the enterprise system 16 may include one or more processors 120, a communications module 122, and a database interface module (not shown) for interfacing with the remote or local datastores to retrieve, modify, and store (e.g., add) resources 18. Communications module 122 enables the enterprise system 16 to communicate with one or more other components of the computing environment 10, such as a user device 12 (or one of its components), via a bus or other communication network, such as the communication network 14. The enterprise system 16 can include at least one memory or memory device 124 that can include a tangible and non-transitory computer-readable medium having stored therein computer programs, sets of instructions, code, or data to be executed by processor 120. FIG. 5 illustrates examples of modules, tools and engines stored in memory on the enterprise system 16 and operated or executed by the processor 120. It can be appreciated that any of the modules, tools, and engines shown in FIG. 5 may also be hosted externally and be available to the enterprise system 16, e.g., via the communications module 122. In the example embodiment shown in FIG. 5, the enterprise system 16 includes an authentication server 126, for authenticating users to access resources 18 of the enterprise, and mobile application server 126 to facilitate a mobile application that can be deployed on mobile user devices 12. The enterprise system 16 can include an access control module (not shown), similar to the security platform 20.

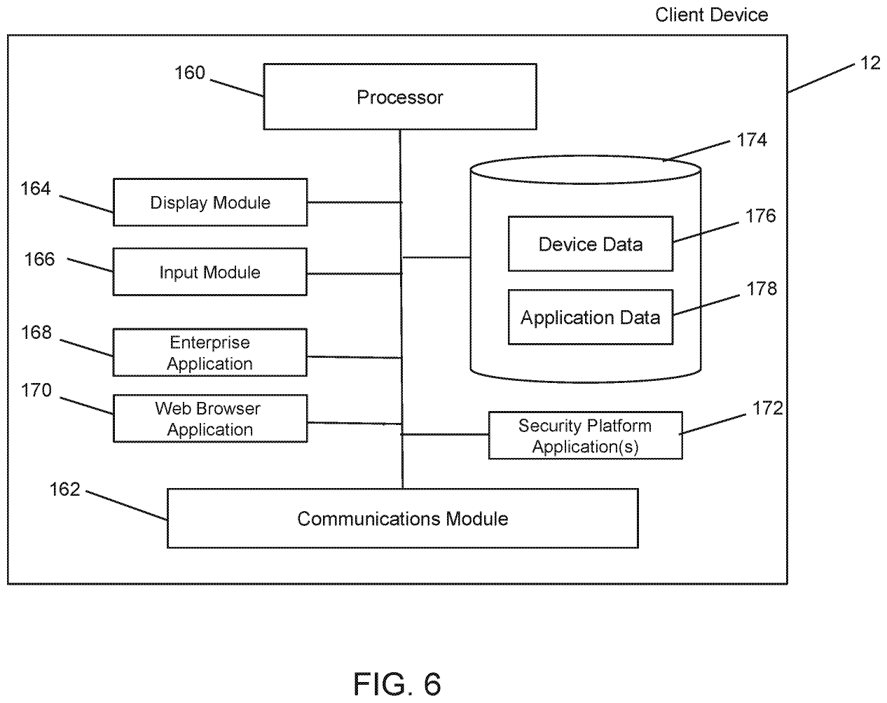

In FIG. 6, an example configuration of a user device 12 is shown. In certain embodiments, the user device 12 may include one or more processors 160, a communications module 162, and a data store 174 storing device data 176 (e.g., data needed to populate a request 13, or to perform a remediation action 44) and application data 178. Communications module 162 enables the user device 12 to communicate with one or more other components of the computing environment 10, such as security platform 20, or enterprise system 16, via a bus or other communication network, such as the communication network 14. While not delineated in FIG. 6, similar to the security platform 20 the user device 12 includes at least one memory or memory device that can include a tangible and non-transitory computer-readable medium having stored therein computer programs, sets of instructions, code, or data to be executed by processor 160. FIG. 6 illustrates examples of modules and applications stored in memory on the user device 12 and operated by the processor 160. It can be appreciated that any of the modules and applications shown in FIG. 6 may also be hosted externally and be available to the user device 12, e.g., via the communications module 162.

In the example embodiment shown in FIG. 6, the user device 12 includes a display module 164 for rendering GUIs and other visual outputs on a display device such as a display screen, and an input module 166 for processing user or other inputs received at the user device 12, e.g., via a touchscreen, input button, transceiver, microphone, keyboard, etc. The user device 12 may also include an enterprise application 168 provided by the enterprise system 16, e.g., for submitting requests to perform mobile banking, investing, or other performing financial services. The user device 12 in this example embodiment also includes a web browser application 170 for accessing Internet-based content, e.g., via a mobile or traditional website and one or applications (not shown) offered by the enterprise system 16 or the security platform 20. The data store 174 may be used to store device data 176, such as, but not limited to, an IP address or a MAC address that uniquely identifies user device 12 within environment 10. The data store 176 may also be used to store authentication data, such as, but not limited to, login credentials, user preferences, cryptographic data (e.g., cryptographic keys), etc.

It will be appreciated that only certain modules, applications, tools, and engines are shown in FIGS. 2 to 6 for ease of illustration and various other components would be provided and utilized by the security platform 20, enterprise system 16, and user device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in security platform 20 or enterprise system 16, or user device 12, or accessible or connectable thereto. Any application or module herein described may be implemented using computer readable/executable instructions that may be stored or otherwise held by such computer readable media.

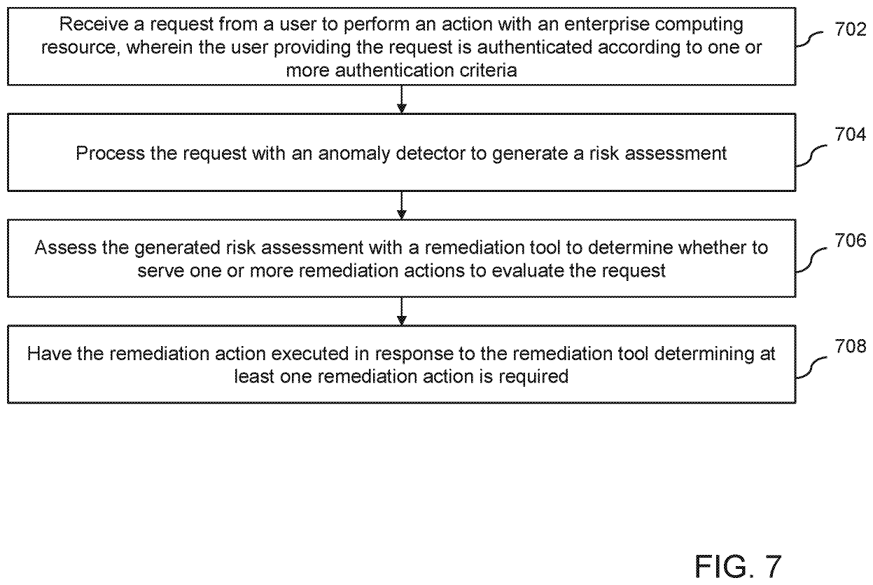

Referring to FIG. 7, a flow diagram of an example method performed by computer executable instructions for assessing actions of authenticated entities within an enterprise system 16 is shown. It is noted that FIG. 7 may be described with reference to elements from the preceding figures for ease of illustration, but the example method is understood not to be limited to the referenced elements.

At block 702, a request 13 is received from a user of a device 12 to perform an action within enterprise computing resources 18. Example embodiment, the request can be received at the proxy server 36, on software local to the device 12 making the request 13, etc.

At block 704, the request 13 is processed with an anomaly detector 38 to generate a risk assessment. The anomaly detector 38 can employ a MLM 27 train to predict the likelihood that an adverse event will result from completion of the actions by the authenticated user associated with the request 13 to generate the risk assessment. The risk assessment can be based on the type of actions associate with the request 13 (e.g., request for more sensitive resources 18 can automatically be assigned a higher risk), the extent of the computing resources 18 required to complete the request 13, etc.

At block 706, the generated risk assessment is processed with a remediation tool 40 to determine whether to serve one or more remediation actions 44 to further evaluate the request 13. The assessment by the remediation tool 40 can incorporate various preconfigured policy considerations, including, for example, risk appetite or acceptability, intrusion appetite (e.g., where the risk assessment process may intrude on completing tasks via the request 13), at least one of functionality associated with the action, a role associated with the user generating the request 13 (e.g., senior employee, junior employee, HR, etc.), the requested action (e.g., amend working product, delete sensitive employee or customer data, etc.), and the enterprise computing resource 18 needed to complete the request 13 (e.g., the resource 18 is a computing resource, or sensitive data, etc.).

The block 708, in response to the remediation tool for determining that at least 1 remediation action 44 is required, a remediation action 44 is required to complete the actions of the request 13. The remediation action 44 can include additional authentication steps by the user submitting the request 13, by parties other than the user (e.g., a supervisor, or a computing resource manager, etc.), or some combination thereof.

In response to the at least one remediation action 44 being successfully completed, the actions associated with the request 13 can be enabled.

In example embodiments, not shown in FIG. 7, a data source (e.g., processed requests in database 22b) used to train the MLM 27 can be monitored to determine whether a threshold (e.g., a drift parameter 30) associated with data drift is satisfied. In example embodiments, data used to train the data source is segregated from subsequent operational data, and the operational data is monitored for drift. In response to the threshold being satisfied, the MLM 27 can be retrained on the data in the monitored data source to reduce an amount of data drift.

In example embodiments, devices 12 are configured to retrieve the MLM 27 from a container image registry 22c to perform risk assessments locally. The container image registry 22c can include a plurality of MLMs 27 in the form of container packages 34, for example, to distribute to a plurality do different devices 12 in the ecosystem of a large enterprise.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for assessing actions of authenticated entities within an enterprise system, the device comprising:
a processor;
a communications module coupled to the processor; and
a memory coupled to the processor, the memory storing computer executable instructions that when executed by the processor cause the processor to:
receive a request from a user to perform an action with an enterprise computing resource, wherein the user providing the request is authenticated according to one or more authentication criteria;
process the request with an anomaly detector to generate a risk assessment, the anomaly detector using a machine learning model trained to predict a likelihood that an adverse event will result from completion of actions by authenticated users to generate the risk assessment;
assess the generated risk assessment with a remediation tool to determine whether to serve one or more remediation actions to evaluate the request; and
have the remediation action executed in response to the remediation tool determining at least one remediation action is required to complete the actions of the request.

2. The device of claim 1, wherein the device is a proxy server positioned between a user device associated with the user and an enterprise platform hosting the enterprise computing resource, and wherein the anomaly detector processes the request after the request is provided to the proxy server.

3. The device of claim 1, wherein the instructions cause the processor to:
in response to the remediation action being successfully completed, enable completion of the action.

4. The device of claim 1, wherein the remediation action can include a further authentication, or an actionable event from a user other than the user associated with the request.

5. The device of claim 1, wherein the instructions cause the processor to:
assess a data source used to train the machine learning model to determine whether a threshold associated with data drift is satisfied; and
in response to the threshold being satisfied, re-train the machine learning model with the data source to reduce an amount of data drift.

6. The device of claim 1, wherein the instructions cause the processor to:
retrieve the machine learning model from a container image registry, the container image registry comprising a plurality of machine learning models in a form of container packages.

7. The device of claim 1, wherein the enterprise resources are cloud computing resources.

8. The device of claim 1, wherein the remediation tools assess the generated risk assessment based on at least one of risk acceptability parameters and intrusiveness parameters.

9. The device of claim 1, wherein the remediation tools assess the generated risk assessment based on at least one of functionality associated with the action, a role associated with the user, the requested action, and the enterprise computing resource.

10. A method of assessing actions of authenticated entities within an enterprise system, the method comprising:
receiving a request from a user to perform an action with an enterprise computing resource of an enterprise platform, wherein the user providing the request is authenticated according to one or more authentication criteria;
processing the request with an anomaly detector to generate a risk assessment, the anomaly detector using a machine learning model trained to predict a likelihood that an adverse event will result from completion of actions by authenticated users to generate the risk assessment;
assessing the generated risk assessment with a remediation tool hosted on the enterprise platform to determine whether to serve one or more remediation actions to evaluate the request; and
having the remediation action executed in response to the remediation tool determining at least one remediation action is required to complete the actions of the request.

11. The method of claim 10, wherein the request is received by a proxy server positioned between a user device associated with the user and the enterprise platform hosting the enterprise computing resource, and wherein the anomaly detector processes the request after the request is provided to the proxy server.

12. The method of claim 11, further comprising:
in response to the remediation action being successfully completed, enabling access via the proxy server to the enterprise computing resource to complete the action.

13. The method of claim 10, wherein the anomaly detector is operable on a user device associated with the user, and the anomaly detector provides the generated risk assessment to the remediation tool hosted on the enterprise platform.

14. The method of claim 12, further comprising:
generating, within the enterprise platform, an updated machine learning model;
packaging the updated machine learning model into a container image; and
updating the machine learning model of the user device with the updated machine learning model in the container image.

15. The method of claim 11, wherein the remediation action is served to the user device via the proxy server.

16. The method of claim 11, wherein the remediation action is served to a user other than the user associated with the request, the remediation action being served via a channel separate from the proxy server.

17. The method of claim 10, further comprising:
assessing a data source used to train the machine learning model to determine whether a threshold associated with data drift is satisfied; and
in response to the threshold being satisfied, re-training the machine learning model with the data source to reduce an amount of data drift.

18. The method of claim 10, wherein the remediation action can include a further authentication, or an actionable event from a user other than the user associated with the request.

19. The method of claim 10, wherein the remediation tool assesses the generated risk assessment based on at least one of risk acceptability parameters, intrusiveness parameters, and a baseline acceptable risk.

20. A non-transitory computer readable medium for assessing actions of authenticated entities within an enterprise system, the computer readable medium comprising computer executable instructions for:
receiving a request from a user to perform an action with an enterprise computing resource, wherein the user providing the request is authenticated according to one or more authentication criteria;
processing the request with an anomaly detector to generate a risk assessment, the anomaly detector using a machine learning model trained to predict a likelihood that an adverse event will result from completion of actions by authenticated users to generate the risk assessment;
assessing the generated risk assessment with a remediation tool to determine whether to serve one or more remediation actions to evaluate the request; and
having the remediation action executed in response to the remediation tool determining at least one remediation action is required to complete the actions of the request.
